(19) United States
(12) Patent Application Publication
(10) Pub. No.: US 2024/0189911 A1
(43) Pub. Date: Jun. 13, 2024

(54) METHOD FOR THE ADDITIVE MANUFACTURING OF A METAL PART

(71) Applicant: INSTITUT DE RECHERCHE TECHNOLOGIQUE JULES VERNE, Bouguenais (FR)

(72) Inventor: Prigent SERGE, La Sappey en Chartreuse (FR)

(21) Appl. No.: 18/285,747

(22) PCT Filed: Apr. 1, 2022
(86) PCT No.: PCT/EP2022/058750

§ 371 Date: Oct. 5, 2023

(30) Foreign Application Priority Data
Apr. 6, 2021 (FR) 2103499

(51) Int. Cl. B22F 12/20; B22F 10/22; B22F 10/50; B22F 12/70; B33Y 10/00; B33Y 30/00; B33Y 40/00; B33Y 80/00

(52) U.S. Cl. CPC B22F 12/20; B22F 10/22; B22F 10/50; B22F 12/70; B33Y 10/00; B33Y 30/00; B33Y 40/00; B33Y 80/00

(57) ABSTRACT

A method for the additive manufacturing of a metal part on a substrate, by adding at least one molten metal layer by layer. The method includes the following steps: a) step a: depositing the molten metal layer by layer, b) step b: simultaneously with step a), cooling, by means of a cooler that is mobile relative to the substrate, a cooling zone located at least around the layer deposited immediately prior to the layer currently being deposited.

### TECHNICAL FIELD

The present invention relates to the additive manufacturing of a metal part. In particular, the invention relates to a method for the additive manufacturing of a metal part on a metal substrate, in particular a very long substrate. The invention also relates to an additive manufacturing facility for implementing the method, and to a metal part obtained by such a method.

### PRIOR ART

To produce a metal part on a substrate by additive manufacturing, it is known practice to deposit, layer by layer, a molten metal on the substrate. However, several problems arise, particularly in the case of long parts, manufactured on substrates which are also long.

One such problem is that the further one moves away from the substrate, upward, as the layers of metal are deposited, the less the heat is discharged into the substrate. However, this heat must be dissipated or the material deposited will collapse. To be specific, if the thermal flows are not carefully controlled, this results in an imbalance between the injected power and the dissipated power. The consequence for the system is that it becomes anisothermal as the temperature evolves until a state of overheating is reached, making it impossible to control the temperature between two deposited layers. When the metals used are titanium alloys or nickel-based superalloys, these are refractory and have thermal conductivity coefficients of the order of 20 W·m⁻¹·K⁻¹ and 10 W·m⁻¹·K⁻¹, respectively. To avoid this overheating and collapse, it is thus necessary to wait after depositing a layer, for example for several minutes, before depositing the next layer, which considerably increases the additive manufacturing time of a part. It is also known practice to reduce the welding energy, which carries a risk of bonding of the metal due to lack of dilution of the substrate in place of welding, and/or to use a fixed cooled bed, consisting of a plate or a bar of copper, but the fixed bed only allows a single geometry.

Another of these problems is linked to the oxidation of the molten metal. This is because the metals used are, for example, titanium alloys which are very reactive to oxygen, when they are in the liquid state or in the solid state at a temperature above 200° ° C., or nickel-based superalloys reactive to oxygen mainly in the liquid state. It is therefore necessary to carry out the metal additive manufacturing in an environment free from oxygen, hydrogen, carbon and nitrogen. To solve this problem, it is known practice to use vacuum enclosures or inerting enclosures or bells or a glove box, that is to say a bell with rubber gloves for handling, or a carriage, in other words an inert gas diffuser. Large enclosures considerably increase the costs and constraints of additive manufacturing.

Lastly, another problem identified relates to the creation of deformations linked to a significant temperature gradient between the layer n−1 previously deposited and the layer n being deposited. To be specific, the local relaxation of stresses at high temperatures, above 700° C., leads to tensile stresses after cooling, according to the Satoh curve. The Satoh test establishes a curve of stress as a function of temperature over a heating then cooling cycle representative of a (heat) welding pass. This test is carried out at zero or low deformation. It is known practice to partially compensate for the deformations observed by an extra machining thickness, which has an economic impact. Furthermore, it is impossible to correct severe deformations by machining and the part is then scrapped. It is also known practice to carry out experiments on the impact between the width, height and dilution of the layer deposited. A reduction in energy, for example, is often technically favorable but affects the rate of deposition and is therefore economically detrimental. Controlling temperature fields is therefore a major technical problem during metal additive manufacturing.

The invention thus aims to propose a method for the additive manufacturing of a metal part which makes it possible to control the temperature fields, and to reduce the constraints, the costs and the time necessary for the additive manufacturing of the part, especially if it is a long part.

### SUMMARY OF THE INVENTION

### Additive Manufacturing Method

The invention achieves this aim in whole or in part by virtue of a method for the additive manufacturing of a metal part on a substrate, by adding at least one molten metal, layer by layer, the method comprising the following steps:
a) Step a: depositing the molten metal layer by layer,
b) Step b: simultaneously with step a), cooling, using a cooler that is movable relative to the substrate, a cooling zone located at least around the last layer deposited (n−1) before the layer (n) being deposited, preferably at least around the layers going from the layer deposited (n−5) to the last layer deposited (n−1) before the layer (n) being deposited.

The invention offers the benefit of a cooler which can move relative to the substrate at least around the layer deposited before the layer being deposited and optionally the layer or layers deposited previously, up to the fifth layer deposited previously, for example, and optionally the layer being deposited. This makes it possible to control the temperature of this or these layers, in particular to dissipate heat to prevent overheating.

“Layer being deposited” means the layer the deposition of which lasts from the beginning to the end of the deposition of the layer and it is considered that there is no transition period between two deposited layers, but there is continuity. Thus, there is always a layer being deposited and a last layer deposited (starting from the second layer being deposited), regardless of whether or not the method is implemented continuously.

Cooling according to step b) may begin as soon as the second layer is deposited. The method may nevertheless include a step consisting of cooling the first layer deposited when it is a single layer and in the process of being deposited.

The cooling zone preferably comprises at least one peripheral zone of the last layer deposited n−1 before the layer being deposited n, transversely thereto, as well as a peripheral zone of at least some, for example between 1 and 5 layers, over a height between approximately 2 and 10 mm, of the n−1 layers deposited before the layer being deposited n, and/or a zone located above a peripheral zone of the last layer deposited n−1 over a height of between approximately 0 and 10 mm, n being in particular between 1 and 5.

“Cooler that is movable relative to the substrate” means that there are three possible embodiments: the cooler is movable, in particular it moves in one direction, for example upward, and the substrate remains fixed; or the cooler remains fixed and the substrate is movable, in particular it moves in one direction, for example downward; or else the cooler and the substrate are both movable, one moving in one direction, for example upward, and the other moving in the opposite direction, for example downward. The cooler may be moved using an automaton or a robot and/or be rigidly secured to the welding equipment so as to move relative to the substrate.

The cooler is preferably fixed relative to the last layer deposited before the layer being deposited and/or relative to the layer being deposited. It can also be stated that the cooler may be movable in a manner synchronized with the last layer deposited before the layer being deposited and/or with the layer being deposited.

The cooler may be one-piece. In this case, the cooler may have a shape that can at least partially match the shape of the layer being deposited, at a distance therefrom.

Alternatively, the cooler may comprise a plurality of walls, in particular plates, in particular between two and eight, which may be independent, connected or not connected to one another, and preferably moving as one. In the case where the cooler comprises a plurality of plates, it may be referred to as multi-plate. A plate may have dimensions of, for example, approximately 50 mm*10 mm*5 mm. Whether the cooler is one-piece or multi-plate, particularly when the cooler is multi-plate, the distance between the cooler and the metal material of the layers in question may be adjusted to obtain the desired temperature for the, in particular for each, layer or layers.

The cooler may include one or more walls formed by copper plates incorporating circuits cooled by a cooling liquid, in particular water or heat transfer fluid. The wall or walls of the cooler may be formed by the circuits themselves in a serpentine arrangement.

The cooler advantageously forms part of a power-controlled cooling system also comprising a control system.

The temperature of the cooling liquid of the cooler, when present, is advantageously controlled by the control system of the cooling system.

The welding power, generally 5 kW, may vary from 500 W to 50 kW depending on the facility. Between 20% and 90% of the energy is to be dissipated, this corresponding approximately to an energy to be discharged of for example between approximately 3 kW and 50 kW.

The temperature of the substrate upstream and at the layers up to, for example, a distance of between 1 mm and 50 mm, in particular between 5 mm and 15 mm, preferably equal to approximately 10 mm upstream from the layer being deposited n up to layer n−5 is advantageously controlled by the cooling system. In particular, the temperature of the substrate, particularly in the zone around the last layer deposited before the layer being deposited and/or the layer being deposited, may be controlled to be between ambient temperature and 600° C. Note that the thermal front actually precedes the layer n by a distance of between 1 mm and 50 mm, in particular between 5 mm and 15 mm, preferably equal to approximately 10 mm.

Step a) may be implemented in such a way that the layers are deposited in a plane not parallel to the substrate.

The plane of the layers deposited in step a) then forms, preferably, an angle substantially orthogonal to the substrate.

The first layer is preferably deposited on a secondary substrate attached to the substrate, in particular close to one end thereof and extending in a plane substantially parallel to the plane of the layers which will be deposited and preferably orthogonal to the substrate. Each layer advantageously has an end, that is to say a layer edge, welded to the substrate at the time of its deposition.

The cooler may be movable along an axis parallel to the substrate relative to the latter, in particular parallel to a longitudinal axis of the substrate. In this case, the substrate may include support points for the relative movement of the cooler. The substrate may itself form a fixed wall closing off the cooling zone on one side.

The method may include a step of injecting, using a diffuser, an inert gas into an inerting cell including the cooling zone during all or some of the implementation of steps a) and b). The inert gas may be injected at least into the cooling zone. The gas may be diffused from a zone below the cooling zone, upward.

By virtue of such a step, the inerting zone may be reduced, while avoiding oxidation of the deposited metal. As a result, the quantity of gas injected is reduced down to just the volume around the cooling zone, which makes it possible to reduce on the one hand the gas cost and on the other hand the gas filling time (time during which nothing was produced in the prior art) since the volume to be filled is reduced. In addition, the part and the torch may be accessed even during the deposition of molten material.

The inerting cell may include and surround the cooling zone and, at least partially, the substrate. The inerting cell may be deployed gradually as the method is implemented. For this purpose, the inerting cell may comprise at least one partition, in particular a partition that is movable relative to the substrate and/or a sliding partition and/or a bellows partition.

When the inerting cell includes a partition that is movable relative to the substrate, this partition and/or the substrate may move, throughout the manufacturing method, in such a way that the upper end of the partition remains at a predetermined, substantially fixed, distance from the layer being deposited.

When the inerting cell includes at least one sliding partition, the latter may be mounted on rails and slide around the part being manufactured for the duration of the method. The inerting cell may also include several sliding partitions, which slide individually, relative to the others, to deploy around the part gradually as the method is implemented. Thus, a single partition may be deployed initially, then, as the method progresses, a second partition is deployed to help delimit the inerting cell, while maintaining a predetermined, substantially fixed, distance between the upper end of the inerting cell and the last layer deposited, etc. until the last layer of the part is deposited.

When the inerting cell has a bellows partition, the bellows is, at the start of the method, not deployed or only slightly deployed. Then, as the method is implemented, the bellows partition is deployed, in particular upward, until it reaches a fully deployed state at the end of the production of the part, in particular while maintaining a substantially fixed predetermined distance between the upper end of the bellows partition and the last layer deposited.

The predetermined substantially fixed distance between the upper end of the inerting cell and the last layer deposited may for example be between 10 and 50 cm.

The inert gas may be cooled to a temperature below ambient temperature using a refrigeration unit or by expansion. The temperature of the inert gas may be at least 100° C. lower than the temperature of the cooling zone. The flow of inert gas may be greater than or equal to 1 m³/h. The gas may be sprayed onto the cooling zone at a speed of at least 0.001 m/s.

The inert gas is preferably chosen from the group consisting of argon, helium and nitrogen. Argon is approximately 40% denser than air. The diffuser is for example a ceramic or refractory metal frit and makes it possible to create a gaseous zone free of air and compatible with welding of titanium, titanium alloys and nickel alloys.

One or more flexible curtains may extend for example to one or more centimeters or even meters around all or part of the inerting cell.

By virtue of the invention, a relatively small zone is delimited around the part where both the temperature and the gas present are controlled.

The metal is for example chosen from the group consisting of titanium, titanium alloys, nickel-based superalloys and steels.

The metal may be supplied before melting in the form of a powder, wire, strip, bar, or any other form.

A welding torch is used for example to deposit the molten metal in step a). The technique may also use an electron beam, laser, plasma or arc.

By virtue of the invention it is possible to produce multiple parts, in particular complex or non-complex parts of great length, for example with a length of greater than 1 m, up to 50 m.

In a particular embodiment, the part is formed by deposition of layers on a first side of the substrate and by deposition of layers on a second side of the substrate, in particular opposite the first side. In this case, the deposition of layers on the first side may be carried out simultaneously with the deposition of layers on the second side. Also in this case, the deposition of layers on the first side is for example carried out symmetrically to the deposition of layers on the second side.

### Additive Manufacturing Facility

The invention also relates, according to another of its aspects, to an additive manufacturing facility for the manufacture of a metal part on a substrate, by adding at least one molten metal, in particular for the implementation of the method as defined above, the facility comprising at least one system for supplying and depositing a molten metal layer by layer, and a cooling system comprising a cooler that is movable relative to the substrate delimiting a cooling zone and configured to cool at least the cooling zone located at least around the last layer deposited before the layer being deposited and optionally around the layer being deposited.

The cooler may be movable along an axis parallel to the substrate, relative to the latter.

The facility may include an inert gas diffuser capable of diffusing an inerting gas in an inerting cell comprising at least the cooling zone.

The cooling system may include a control system capable of controlling the temperature in the zone delimited by the cooler, the control system being for example capable of controlling mobility along one or more axes of the cooler, in particular of the walls of the cooler and/or the temperature of the cooling liquid.

### Metal Part

The invention also relates, according to another of its aspects, in combination with the above, to a metal part obtained using the method as defined above, produced layer by layer on the substrate, each layer extending in a plane substantially orthogonal to the substrate.

### BRIEF DESCRIPTION OF THE DRAWINGS

The invention can be understood more clearly on reading the following detailed description of non-limiting implementation examples, and on studying the appended drawing, in which:

FIG. 1 shows, schematically and in perspective, an example of a facility for implementing a method for the additive manufacturing of a metal part according to the prior art,

FIG. 2 shows, schematically, partially and in perspective, an example of a facility according to the invention, for implementing an example of a method for the additive manufacturing, according to the invention, of a metal part on a substrate, at the beginning of said method,

FIG. 3 is a view similar to FIG. 2, after deposition of a certain number of layers,

FIG. 4 is a view similar to FIGS. 2 and 3 toward the end of the implementation of the method,

FIG. 5 is an isolated, schematic and perspective view of an example of a one-piece cooler that may be used during the method according to the invention,

FIG. 6 shows, schematically, partially and in perspective, a facility according to the invention showing another example of positioning of the cooler during the implementation of the method according to the invention,

FIG. 7 shows, schematically and in perspective, another implementation example of the additive manufacturing method according to the invention,

FIG. 8 shows, schematically and in perspective, another implementation example of the additive manufacturing method according to the invention,

FIG. 9 shows, schematically and in perspective, another implementation example of the additive manufacturing method according to the invention,

FIG. 10 shows, in schematic and partial longitudinal sectional view, an example of a facility for implementing the method according to the invention,

FIG. 11 is a view similar to FIG. 10 of the same facility after deposition of a certain number of layers,

FIG. 12 depicts, in isolation and schematically in sectional view, an example of a bellows partition which may be used during the implementation of the method according to the invention,

FIG. 13 schematically shows a top view of an example of a part that may be obtained using the method of the invention,

FIG. 14 shows, in cross section along XIV, schematically, the part of FIG. 13, surrounded by the cooler,

FIG. 15 shows, schematically in cross section, another example of a part that may be manufactured with the method according to the invention,

FIG. 16 shows, schematically in cross section, another example of a part that may be manufactured with the method according to the invention,

FIG. 17 shows, schematically in cross section, another example of a part that may be manufactured with the method according to the invention,

FIG. 18 shows, schematically in cross section, another example of a part that may be manufactured with the method according to the invention,

FIG. 19 shows, schematically in cross section, another example of a part that may be manufactured with the method according to the invention, and

FIG. 20 shows, schematically in cross section, another example of a part that may be manufactured with the method according to the invention.

### DETAILED DESCRIPTION

In the remainder of the description, identical elements or identical functions bear the same reference sign. For the sake of conciseness of the present description, they are not described with reference to each of the figures, only the differences between the embodiments being described.

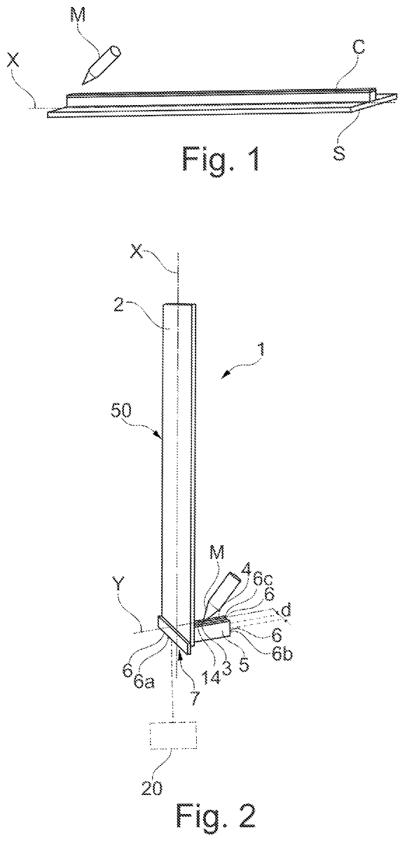

FIG. 1 depicts an example of the implementation of an additive manufacturing method used in the prior art. A molten metal M, for example a metal wire melted using a welding torch, is deposited on a substrate S, in the form of layers C deposited one on top of the other on the substrate S, along the longitudinal axis X of said substrate and parallel thereto. The substrate S has a great length, for example greater than 1 m. The problems described above result, once a certain deposition height is reached, in the collapse of the stack of layers, the creation of deformations and/or require interruption of the method after the deposition of each layer.

FIGS. 2 to 4 show an example of the implementation of the method according to the invention with a facility 1 according to an embodiment of the invention for the production by additive manufacturing of a metal part 50. In this example, this involves creating a reinforcing rib 11, or stiffener, on a substrate 2, along the latter. The substrate 2 has a great length, for example a length greater than 1 m. The metal part 50 includes the rib 11 and the substrate 2. A welding torch deposits molten metal M in the form of layers 14, layer by layer, to form the part.

The facility 1 includes a cooler 5, movable relative to the substrate 2, but fixed relative to the layer 14, designated n, being deposited at a given time. In other words, the cooler 5 moves as the layers are deposited so as to be fixed relative to the layer being deposited.

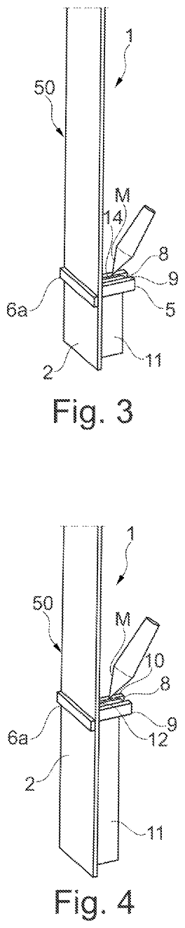

The cooler 5 delimits a cooling zone 8 during the deposition of the layers 14, as can be seen in FIGS. 3 and 4, around at least the last layer 14 deposited n−1 and optionally the layer 14 being deposited n in order to obtain an optimal temperature within this cooling zone 8 and dissipate the heat from the molten metal M deposited layer by layer, as the metal part 50 is constructed.

In the example illustrated, the cooler 5 delimits a cooling zone 8 which surrounds the n−5 layers 14 deposited before the layer 14 being deposited n. The cooling zone 8 comprises at least one peripheral zone of the last layer deposited n−1 before the layer being deposited n, transversely thereto, as well as a peripheral zone of at least some of the n−1 layers, in this example between 1 and 5 layers, over a height of between approximately 2 and 10 mm.

In the example illustrated in FIGS. 2 to 4, the cooler 5 comprises a plurality of walls forming plates 6, numbering three in this example, namely an outer plate 6a, arranged on the opposite side relative to the substrate 2, and plates 6b and 6c, parallel to one another in this example, laterally surrounding the layers 14 parallel to the axis Y. The plates 6 extend in a vertical plane in the example illustrated, perpendicular to the plane of the layers 14. The cooler 5 is in this example multi-plate. Each plate 6 may consist of a copper plate incorporating circuits cooled by a cooling liquid, in particular water or heat transfer fluid.

As can be seen in FIGS. 2, 3 and 4, the cooler 5 is fixed relative to the last layer 14 deposited n−1 before the layer 14 n being deposited, always surrounding the latter as well as optionally the layer being deposited n and/or one or more previous layers. The cooler 5 may be attached to the holder for the welding torch and move together with the torch, during the implementation of the method.

In another embodiment not illustrated, it is the substrate 2 which is movable during the implementation of the method, while the cooler 5 remains fixed, as does the welding torch for example.

The cooler 5 forms part of a cooling system 7 which further comprises a control system 20, shown in dotted lines in FIG. 2, formed for example by a remote computer, making it possible to control the temperature of the plates 6 and hence of the cooling zone 8, in such a way that the latter allows cooling of the layer n or layer n−1 and optionally the layers below the layer n−1, for example up to the layer n−5.

In the example illustrated, the layers 14 are deposited not parallel to the substrate 2 as in the prior art, but at an angle. In this example, the layers 14 are deposited perpendicular to the substrate 2 extending along the axis X. Each layer 14 has two opposite edges 9, a free edge 10 and an edge 12 in contact with the substrate 2. The end edge 12 of each layer 14 is welded to the substrate 2 during the deposition of the layer 14. In the facility 1, as shown, the substrate 2 is positioned vertically. It could be arranged in an inclined manner without departing from the scope of the invention. A secondary substrate 3, visible in FIG. 2, is attached, for example by welding, close to the lower end of the substrate 2, orthogonal to the latter, along an axis Y. The secondary substrate 3 may have a base surface 4 corresponding to the surface area of each layer 14 of metal to be deposited during the additive manufacturing method. The base surface 4 may alternatively have a surface greater than that of each layer 14.

The metal deposited is in this example a titanium-based alloy, but it could constitute a nickel-based superalloy or any other weldable metal alloy without departing from the scope of the invention. The metal is provided in the form of wire in this example. The metal M is melted in this example using a welding torch, only part of which is shown for the sake of clarity of the drawing.

In the present case, it is sought to maintain the temperature in the cooling zone 8 at a temperature between ambient temperature and 600° ° C., in particular between 100° ° C. and 300° C. The respective distances d between the plates 6a and 6b and the respective edges 9 of the layers 14 deposited may be between approximately 0 and 2 mm. Preferably, contact is ensured between the plates 6a and 6b and the respective edges 9 for exchange by conduction.

This distance d may be modulated to adjust the temperature within the cooling zone 8 delimited by the cooler 5. The surface of the cooler and its heat dissipation flow in kW/h may also be modulated.

In this example, the cooler 5 moves such that the cooling zone 8 has a constant volume unless the distance between the plates 6b, respectively 6c, and the corresponding edge 9 of the layers deposited n−1, etc. is modulated.

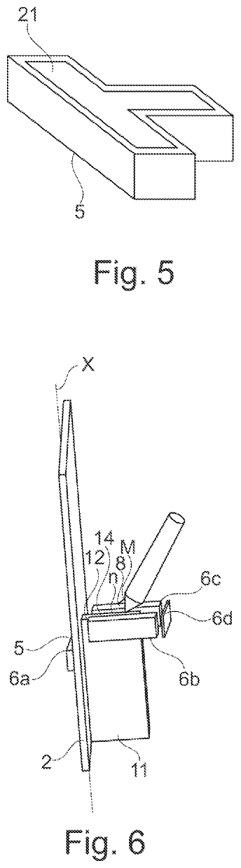

The cooler 5 is multi-plate in the example of FIGS. 2 to 4. In the example of FIG. 5, the cooler 5 is one-piece, having an overall shape and a through opening 21 allowing it to surround the substrate 2 and the layers 14 and to define the cooling zone 8.

In another variant of a cooler 5 in multi-plate form, the cooler 5 could include a fourth plate 6d parallel to the plate 6a but located at the other end of the plates 6b and 6c so as to face the free edge 10 of the rib 11 under construction. This could make it possible to completely close off, laterally, the cooling zone 8.

Such a plate 6d is present in the exemplary embodiment of FIG. 6. Furthermore, in this example, the cooling zone 8 delimited around the layer n−1 and the layers previously deposited also extends around and above the layer n being deposited along the longitudinal axis X of the substrate 2.

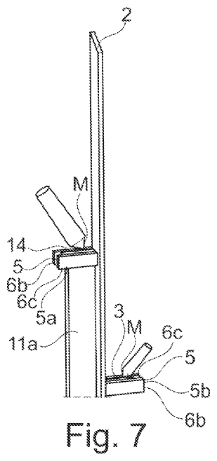

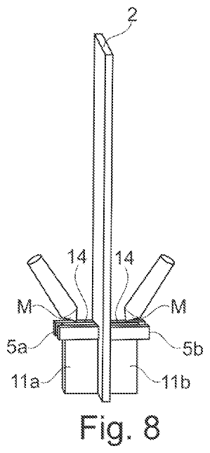

FIGS. 7 and 8 show the possibility of producing on either side of the same substrate 2 two ribs 11, referenced 11a and 11b, arranged symmetrically or non-symmetrically with respect to the substrate 2. The technique used for each side is the same as defined above, according to the invention.

In the example of FIG. 7, the advancement on one side and the other is not the same, the rib 11a being produced before the other rib. Two coolers 5 are provided, referenced 5a and 5b. The coolers 5 each comprise only two plates 6b and 6c, and are movable independently of one another, relative to the substrate 2.

In the example of FIG. 8, the ribs 11a and 11b are formed simultaneously and the coolers 5a and 5b are movable simultaneously. It is even possible to have only one cooler 5 in this embodiment, according to a variant.

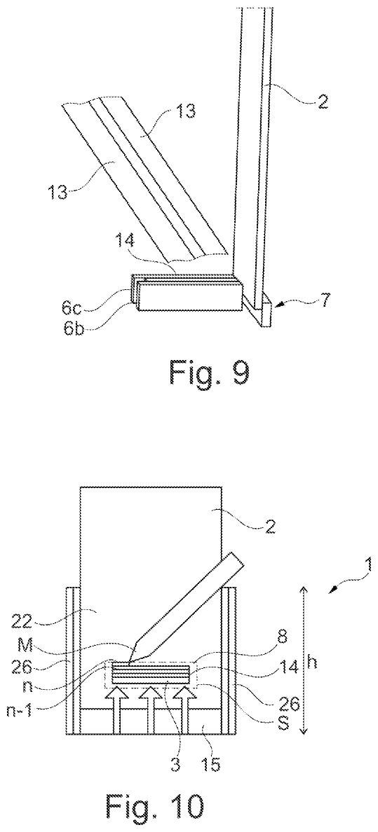

The example in FIG. 9 illustrates the possibility of depositing a metal not in the form of molten wire but in the form of bars 13 which are deposited in the molten state. This makes it possible in particular to increase the rate of deposition of the layers 14.

By virtue of the invention, access to the layers during deposition is not hindered by the cooler 5 which, with the cooling zone 8 which it delimits, only laterally encloses the zone with the layer n−1 deposited, optionally the layer n being deposited, the underlying layers already deposited and optionally a zone above the layer n being deposited.

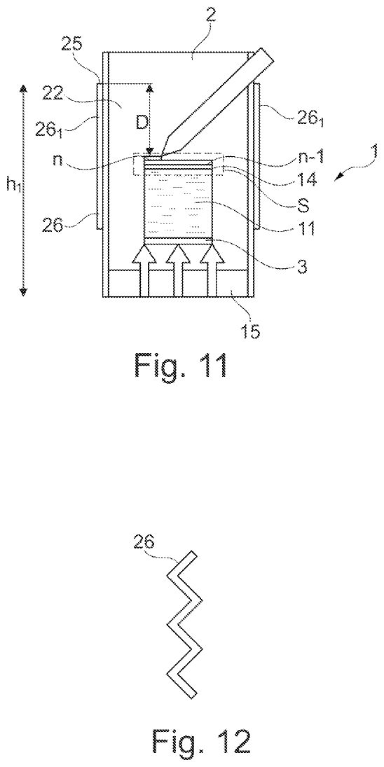

FIGS. 10 and 11 show another example of a facility 1 for implementing the method according to the invention, comprising, in addition to the cooling system 7, an inerting system 15 with injection of inert gas, in this example argon. The gas is injected in this example from the bottom, using a diffuser, toward an inerting cell 22 including the cooling zone 8 delimited by the cooler 5 shown in dotted lines, and the zone around this cooling zone 8, in the direction illustrated by the arrows, i.e. upward.

FIG. 10 shows the start of the implementation of the method according to the invention, the number of layers deposited being low, while FIG. 11 shows the facility after implementation of the method on a high number of layers.

In the example of FIGS. 10 and 11, the inerting cell 22 is delimited by at least one, in particular several partitions 26 which may slide relative to one another telescopically, in order to extend the inerting cell 22 as the method is implemented. The partitions 26 are superimposed laterally at the start. They thus extend over a height h equal to the height of a partition 26 in FIG. 10. In FIG. 11, the partition 261 located on the outside has slid upward such that the total height is the height h₁ greater than the height h. The inerting cell 22 has therefore expanded in this example during the implementation of the additive manufacturing method according to the invention.

Note that the distance D between the upper end 25 of the inerting cell 22 and therefore of the highest partition 26 and the layer being deposited n may be constant and predetermined during the method for implementation according to the invention, having for example a value between 10 and 50 cm.

There may of course be a number of partitions 26, sliding relative to one another, greater than two on each side without departing from the scope of the invention.

FIG. 12 shows in isolation a bellows partition 26 partially deployed to allow it to extend in order to delimit the inerting cell 22, replacing the partitions 26 of FIGS. 10 and 11.

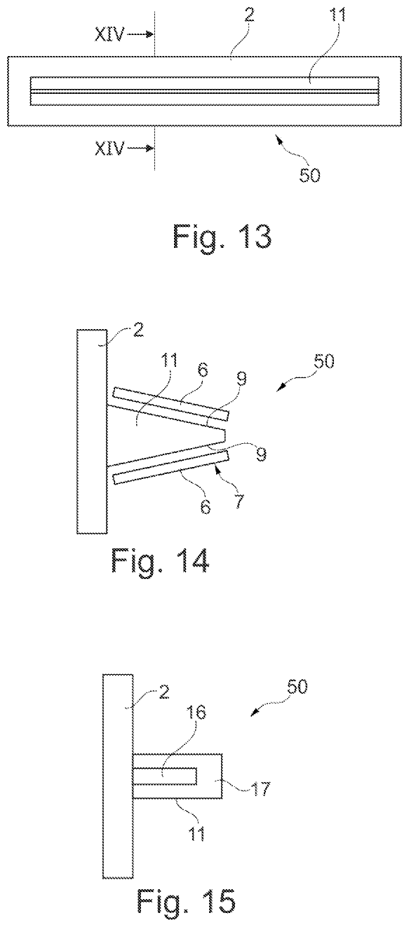

FIGS. 13 and 14 show a metal part 50 with a rib 11 of pyramidal shape, as can be seen. Naturally, the deposition of the layers will be adapted to suit this pyramidal shape. The plates 6 of the cooler 5 may be, as shown in this figure, arranged parallel to the edges 9 of the rib 11.

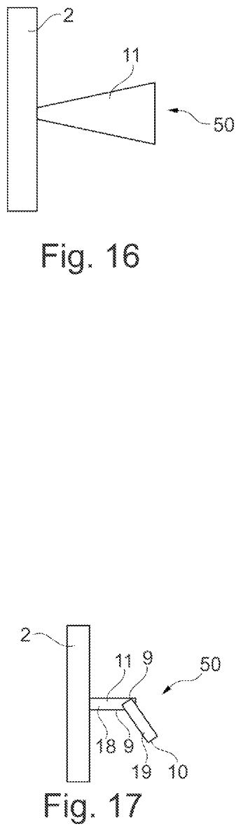

Other examples of metal parts 50 according to the invention produced in accordance with the method according to the invention have been shown in FIGS. 15 to 20. In the example of FIG. 15, the rib 11 seen from above changes dimension in terms of height and thickness on the axis X, with a part 17 more bulky than the part 16. In the example of FIG. 16, the rib 11 is in the shape of an inverted pyramid.

In the example of FIG. 17, the rib 11 comprises two parts 18 and 19 forming an angle between them. In this case, the plates 6 of the cooler 5 may have angles so as to have at any point on the plate 6 a constant distance relative to the edge 9 and optionally 10 of the rib 11.

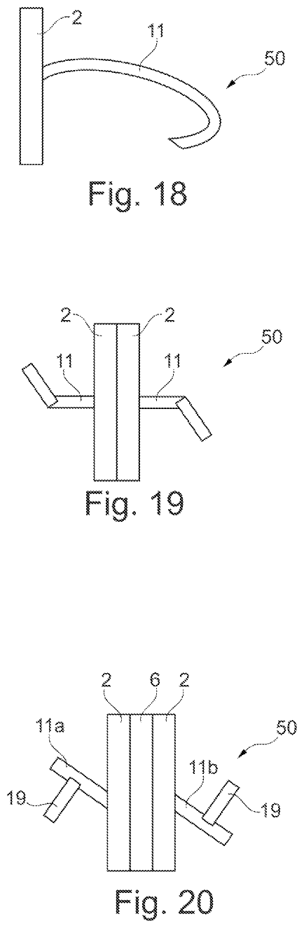

In the example of FIG. 18, the rib 11 has a curved shape. In this case, the shape of the plates 6 will also be adapted to this curved shape to maintain a predetermined range of temperatures within the cooling zone 8 delimited by the cooler 5.

In the example of FIG. 19, there are two substrates 2 arranged one against the other and each supporting a rib 11 having an angle, in a non-symmetrical manner. It would not be departing from the scope of the invention if the ribs 11 were symmetrical to one another.

In FIG. 20, the substrates 2 are separated, unlike in FIG. 19. Between the substrates 2 a part of the cooler 5 has been incorporated in the form of a plate. The ribs 11 in this example include a protrusion 19.

In all these examples, the shape of the cooler 5 and the plates 6 is of course adapted so as to have, in the cooling zone 8, the desired temperature.

The invention is not limited to the examples which have just been described. In particular, an embodiment according to the invention may be that of FIG. 1, including a cooler 5 as described above.

The substrate 2 may be movable and the cooler 5 may be fixed, during the implementation of the method.

The metal may be in the form of a powder, wire, bar, strip or in another form. The layers 14 may be deposited in an inclined plane that is not orthogonal to the plane of the substrate 2. The secondary substrate 3 may form a non-right angle with the substrate 2.

1. A method for the additive manufacturing of a metal part on a substrate, by adding at least one molten metal, layer by layer, the method comprising the following steps:
a) step a: depositing the molten metal layer by layer,
b) step b: simultaneously with step a), cooling, using a cooler that is movable relative to the substrate, a cooling zone located at least around the last layer deposited (n−1) before the layer (n) being deposited.

2. The method as claimed in claim 1, wherein the cooling zone comprises at least one peripheral zone of the last layer deposited (n−1) before the layer being deposited (n), transversely thereto, as well as a peripheral zone of at least some of the n−1 layers deposited before the layer being deposited (n), and/or a zone located above a peripheral zone of the last layer deposited (n−1), n being in particular between 1 and 5.

3. The method as claimed in claim 1, wherein the cooler is one-piece.

4. The method as claimed in claim 1, wherein the cooler comprises a plurality of walls forming plates.

5. The method as claimed in claim 4, wherein the distance between said at least one plate and the metal material of the layers in question is adjusted to obtain the desired temperature for the, in particular for each, layer or layers.

6. The method as claimed in claim 1, wherein step a) is implemented in such a way that the layers are deposited in a plane not parallel to the substrate.

7. The method as claimed in claim 6, wherein the plane of the layers deposited in step a) forms an angle substantially orthogonal to the substrate.

8. The method as claimed in claim 6, wherein the first layer is deposited on a secondary substrate attached to the substrate and extending in a plane substantially parallel to the plane of the layers which will be deposited and preferably orthogonal to the substrate.

9. The method as claimed in claim 6, wherein the cooler is movable along an axis (X) parallel to the substrate relative to the latter.

10. The method as claimed in claim 1, including a step of injecting, using a diffuser, an inert gas into an inerting cell including the cooling zone during all or some of the implementation of steps a) and b).

11. The method as claimed in claim 1, wherein the part is formed by deposition of layers on a first side of the substrate and by deposition of layers on a second side of the substrate.

12. An additive manufacturing facility for the manufacture of a metal part on a substrate, by adding at least one molten metal, in particular for the implementation of the method as claimed in claim 1, the facility comprising a system for supplying and depositing a molten metal layer by layer, and a cooling system comprising a cooler that is movable relative to the substrate delimiting a cooling zone and configured to cool at least the cooling zone located at least around the last layer deposited (n−1) before the layer (n) being deposited.

13. The facility as claimed in claim 12, the cooler being movable along an axis (X) parallel to the substrate, relative to the latter.

14. The facility as claimed in claim 12, including an inert gas diffuser capable of diffusing an inerting gas in an inerting cell comprising at least the cooling zone.

15. A metal part obtained using the method as claimed in claim 7, produced layer by layer on the substrate, each layer extending in a plane substantially orthogonal to the substrate.
